(19) United States
(12) Patent Application Publication
(10) Pub. No.: US 2007/0073547 A1
(43) Pub. Date: Mar. 29, 2007

(54) Method for determining useful life of a vehicle

(76) Inventors: Thomas L. Kondrat, Washington, MI (US); Richard J. Vance, Troy, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/237,037

(22) Filed: Sep. 26, 2005

(51) Int. Cl. G06Q 10/00

(52) U.S. Cl. 705/1

(57) ABSTRACT

A method for determining the useful life of a vehicle includes a distribution process for estimating a size of at least one group of vehicles; a determining process for determining a size of a subgroup of the vehicles, wherein each vehicle of the subgroup has a common defect; and a calculating process for calculating a useful life based on the size of the subgroup and the size of the group.

### FIELD OF THE INVENTION

The present invention relates to a method for determining the useful life of a vehicle.

### BACKGROUND

Maintenance issues occasionally arise in some products or goods such as, for example, vehicles. Such maintenance issues may arise due to expiration of the useful life of a vehicle. Expiration of the useful life of a vehicle may necessitate costly maintenance or repair procedures.

### SUMMARY OF THE INVENTION

A method for determining the useful life of a vehicle includes a distribution process for estimating a size of at least one group of vehicles, wherein each vehicle within the group share one or more attributes; a determining process for determining a size of a subgroup of the vehicles, wherein each vehicle of the subgroup has a common defect; and a calculating process for calculating a useful life of a vehicle based on the size of the subgroup and the size of the group.

### BRIEF DESCRIPTION OF THE DRAWINGS

The present invention will now be described, by way of example, with reference to the accompanying drawings, in which:

FIG. 1 is a flow chart of a process for determining a useful life of a vehicle according to an embodiment of the invention;

FIG. 2 is a flow chart of a process for determining a useful life of a subset of a group according to an embodiment of the invention;

FIG. 3 is a flow chart for identifying subsets according to an embodiment of the invention;

FIG. 4 is a chart setting forth vehicle information according to an embodiment of the invention;

FIG. 5 is a graphical view of a vehicle distribution according to an embodiment of the invention;

FIG. 6 is a graphical view of an error rate distribution according to an embodiment of the invention;

FIG. 7 is a graphical view of an error rate distribution according to an embodiment of the invention; and

FIG. 8 is a graphical view for identifying subsets according to an embodiment of the invention.

### DETAILED DESCRIPTION

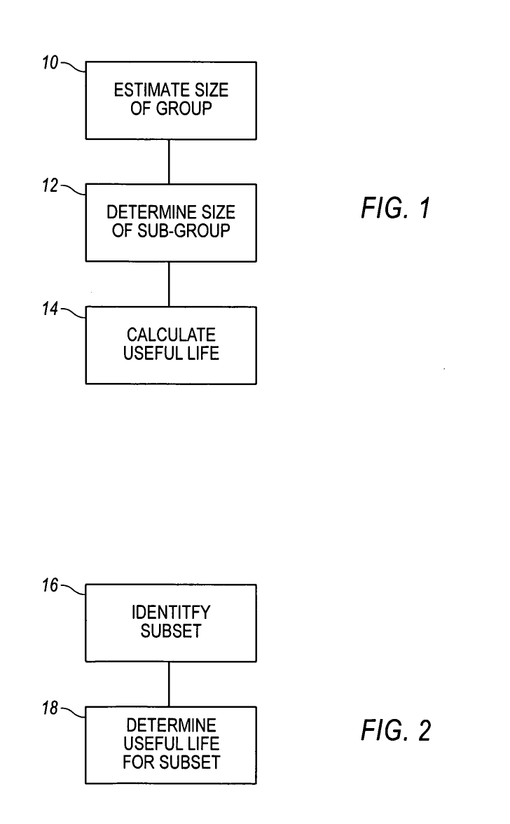

Referring now to FIG. 1, providing a method for determining a useful life of a vehicle is shown and described. In an exemplary embodiment, the method calculates a useful life based on a number of vehicles at a particular age and a number of vehicles at the particular age that have a specified common maintenance issues. More specifically, in an exemplary embodiment, the method illustrated in FIG. 1 includes step 10 for estimating the size of a group, step 12 for determining a size of a subgroup, and step 14 for calculating a useful life. In step 10, estimating the size of a group, a group of vehicles is identified that is at a particular age. The age of the vehicles may be measured by time, miles, wear, or any other measure understood by one skilled in the art for measuring an age of the vehicle. For example, the group may comprise the number of vehicles that were produced at a given year, such as 1996 , and have reached a particular mileage, such as 60,000 -70,000 miles. In an embodiment, these vehicles constitute a group. The estimate of the size of the group may be performed through any known statistical or other technique, such as Kaplan-Meier estimates, generating logarithmic curves, or any other known means of estimating group size based on one or more distribution models. For example, in an embodiment, a logarithmic distribution may be used to estimate a reduction in the number of vehicles that have reached a given age due to expiration of the useful life of components within the vehicle, age expectancy, or any other consideration that influences the expected useful life of a vehicle.

In step 12, once the size of the group is estimated, the size of a subgroup may then be determined. In an embodiment, the size of the subgroup is the number of vehicles in the group that have the particular defect. In another embodiment, the size of the subgroup is a number of vehicles in the group that do not have the particular defect. For example, without limitation, the size of the subgroup may be the number of vehicles in the group that have or do not have a defective alternator. The size of the subgroup may be something more general such as the number of vehicles that have or do not have a defect of any kind. The size of the subgroup may also be based on any other component or attribute of the vehicles as will be understood by one skilled in the art.

In step 14, a useful life is determined based on the size of the subgroup 12 and the size of the group 10. In an embodiment, the useful life may be determined by dividing the size of the subgroup by the size of the group. In one example, the resulting number represents the useful life. For example, a useful life of 1 would indicate that (in the instance where the subgroup is defined by a number of vehicles that do not have a particular defect) none of the vehicles contain the given defect. Likewise, in the same instance, a useful life of 0.5 would indicate that 50% of the vehicles in the group have the given defect.

Referring now to FIG. 2, a method for determining a useful life of a subset is described. A subset is a portion of the group 10 that has a particular attribute. For example, the subset may be all vehicles having a particular engine type or other components. The attributes may also include other types or external attributes that are common to the group. For example, an attribute may be a location where the vehicles are manufactured, a location where the vehicles are sold or driven, type of driver who owns the vehicle (such as age, gender etc.) or any other attribute understandable to one skilled in the art.

The method for determining the failure rate of a subset first involves filtering the group 10 according to the particular attribute and then calculating an error rate. Accordingly, with reference to FIG. 2, a particular subset of group 10 is identified in step 16. In step 18, a useful life is determined for that particular subset. The useful life, in an embodiment, may be calculated in a manner similar to that discussed above. For example, the number of vehicles in the subset (those having the particular attribute) may be determined and a number of vehicles in the subset that do not have the defect may be determined. An error rate may then, in an embodiment, be calculated by dividing the number of vehicles within the subset that do not have the defect by the total number of vehicles in the subset. For example, if the subset includes vehicles having the attribute of being manufactured at location X, then the number of vehicles in the subset that do not have a particular defect (such as, for example, a defective alternator) are divided by the total number of vehicles in the subset to result in the error rate.

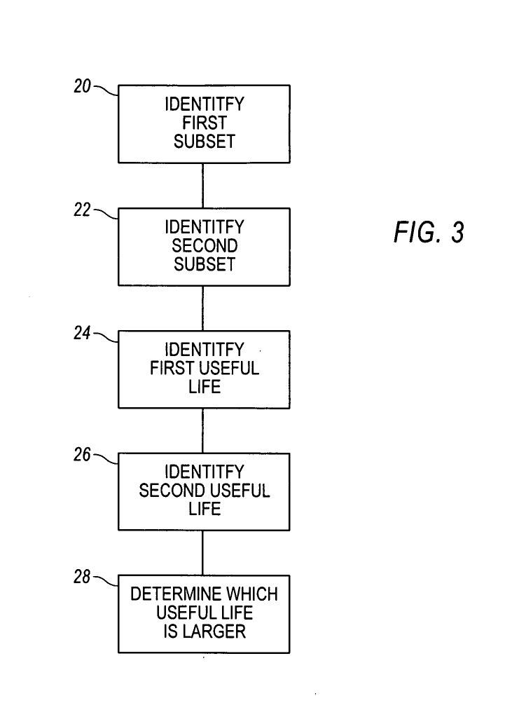

Referring now to FIG. 3, a second exemplary embodiment of the invention is shown and described. In FIG. 3, a number of different subsets are identified, and a useful life is determined for each subset. In an exemplary embodiment, by generating error rates for a number of different subsets, the particular subset that is most likely to cause (or be associated with the source of) a specified defect may be identified. For example, if a first subset involves vehicles manufactured at location X and a second subset involves vehicles manufactured at location Y, then a useful life can be determined for subsets X and Y respectively. If the useful life for location X is for example 0.3 and the useful life for location Y is for example 0.9, then it may be determined with high confidence that vehicles produced at location X are more likely to have the observed or monitored an expiration of useful life. Accordingly, in step 20 of FIG. 3, a first subset of group 10 is identified. In step 22, a second subset of group 10 is identified. In step 24, a first useful life is calculated for the first subset. In step 26, a second useful life is calculated for the second subset. In step 28, it is determined which useful life is smaller or larger.

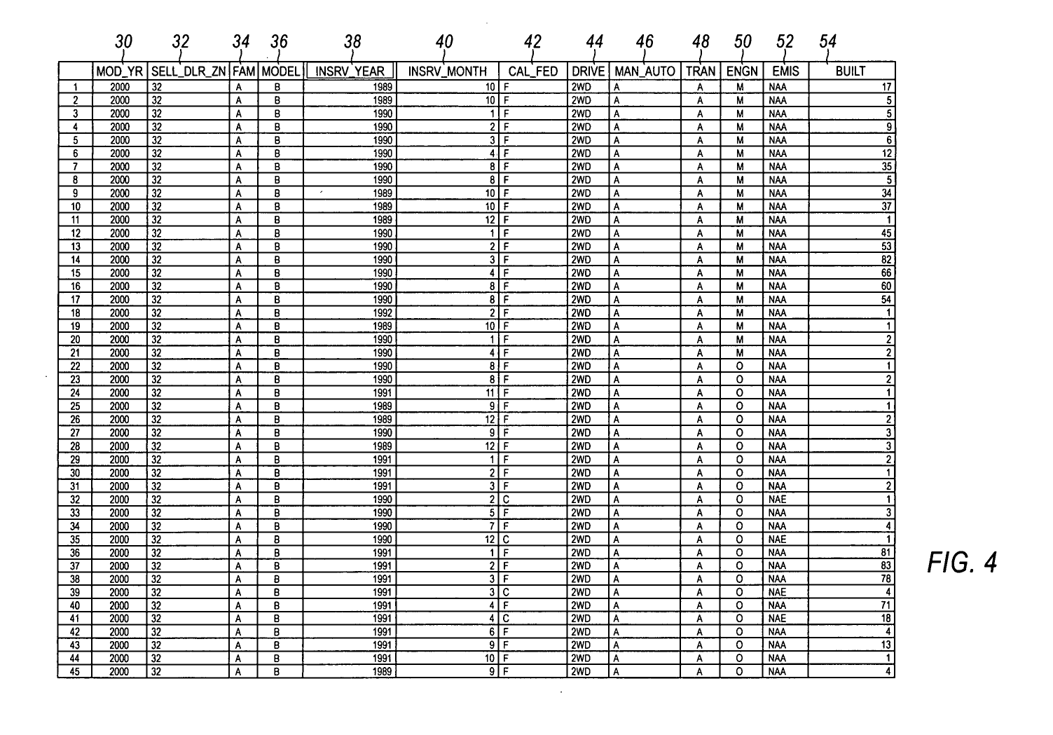

Referring now to FIGS. 4-8, an example according to an exemplary embodiment of the invention is shown and described. In FIG. 4, information regarding a group of vehicles may be associated with or correlated into a spreadsheet. By way of example, in FIG. 4, column 30 defines the model year, column 32 identifies or defines a particular dealer, column 34 identifies or defines a family type, column 36 identifies or defines a vehicle model, column 38 identifies or defines the year that the vehicle was sold, column 40 identifies or defines the month that the particular vehicle was sold, column 44 identifies or defines whether the vehicle is two wheel or four-wheel drive, column 46 identifies or defines whether the vehicle has a manual or automatic transmission, column 48 further identifies or defines the transmission type used in the vehicle, column 50 identifies or defines the type of engine used in the vehicle, column 52 identifies or defines emissions equipment on the vehicle, and column 54 identifies or defines the number of vehicles built. One skilled in the art will understand that more, less, or different categories may be used.

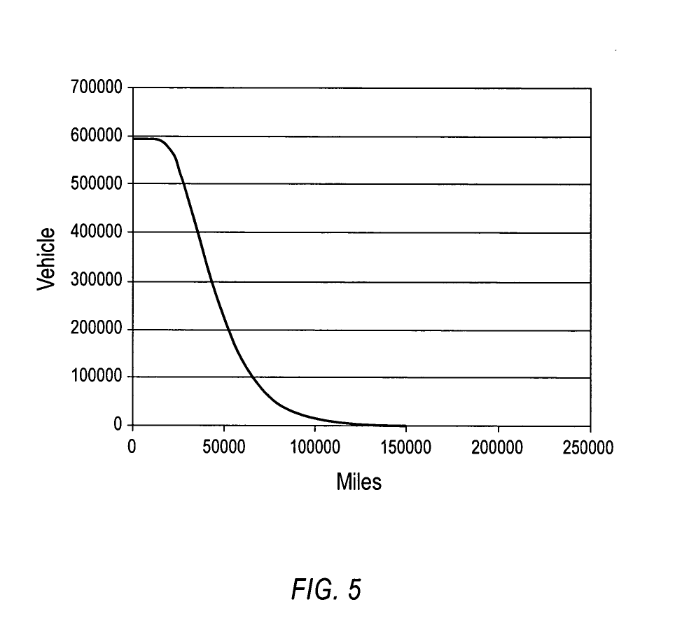

In FIG. 5, a distribution is generated for the vehicles of model year 2000 (shown in column 30 of FIG. 4), based on the number of vehicles in service or that have reached a designated mileage. For example, approximately 200,000 vehicles have reached a mileage of 50,000 miles. Likewise, approximately 600,000 vehicles are in service at the 0 mile mark, meaning that approximately 600,000 vehicles were initially sold at model year 2000.

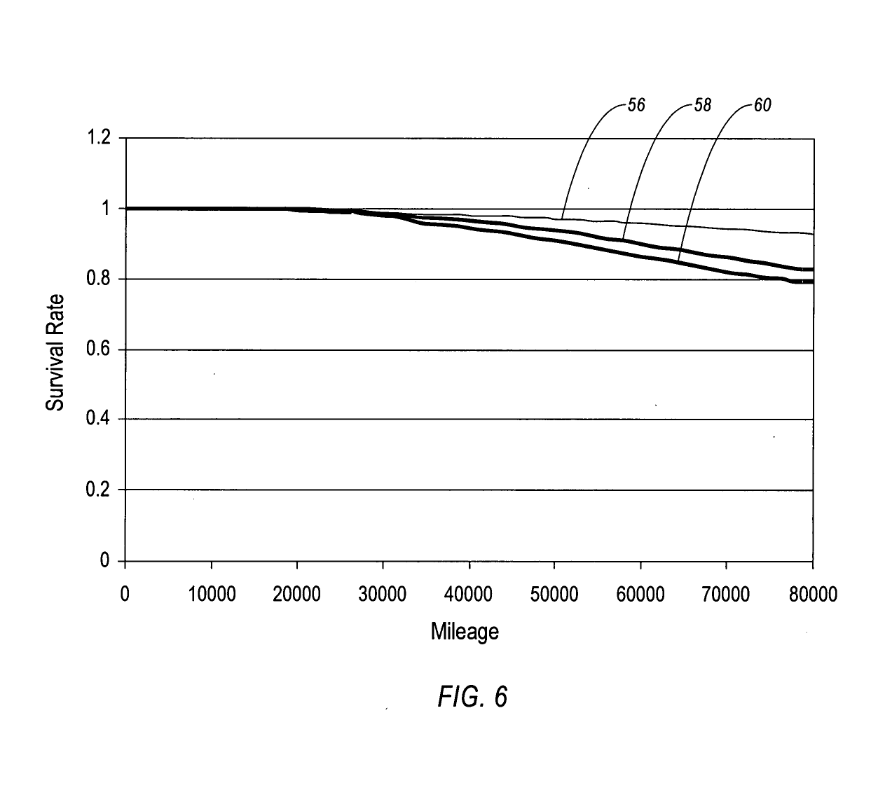

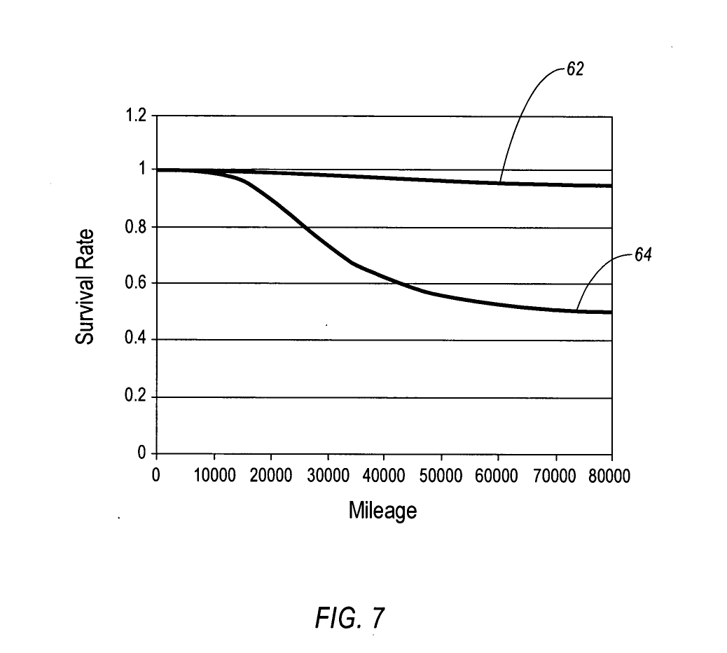

Referring now to FIG. 6, the illustrated graph provides error rates for the vehicles in FIG. 4 over various mileages. Each line 56, 58 or 60, in an embodiment, represents a different subset of the vehicles. For example, line 56 may represent a first model type (see 36 in FIG. 4), while line 58 may represent a second model type, and line 60 may represent a third model type. As can be seen, over time (shown as mileage in FIG. 6), the error rates differ for each of the model types 56, 58 or 60. The error rates are, in an exemplary embodiment, generated by dividing the number of vehicles in service at a particular mileage by a number of vehicles that do not have a particular defect at that mileage. Similarly, FIG. 7 illustrates another example of error rates as a function of various mileages. For example, line 62 may represent error rates for vehicles having automatic transmissions while line 64 may represent standard transmissions as illustrated in FIG. 4. As can be seen, the error rate depicted by line 62 is substantially better than the error rate represented by line 64.

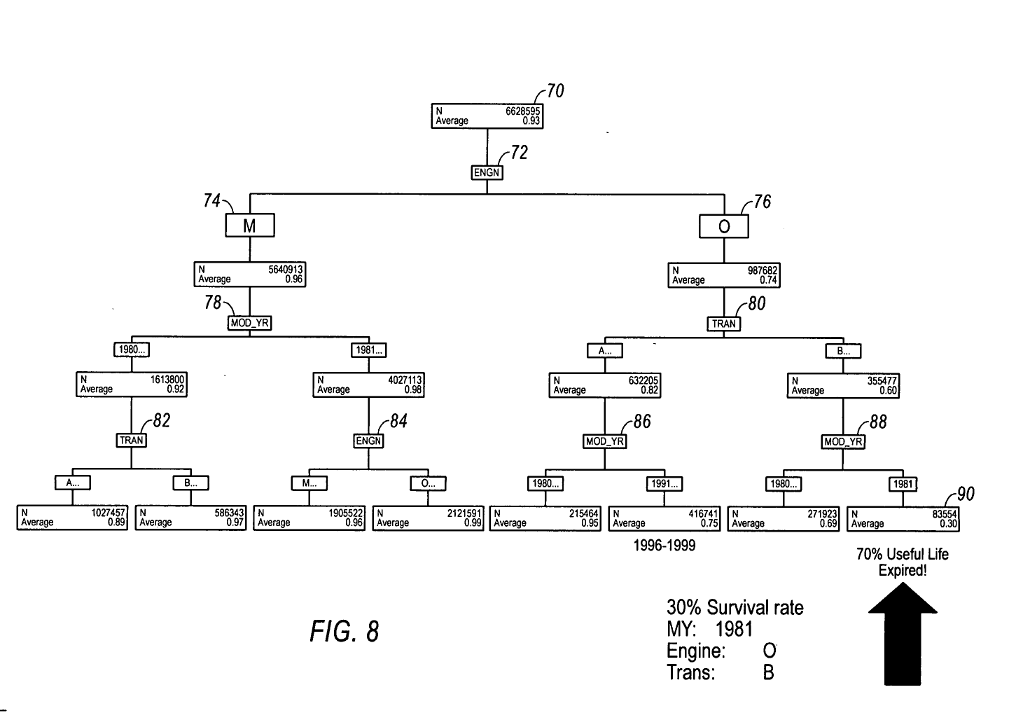

Referring now to FIG. 8, another exemplary embodiment of the invention is shown and described. In FIG. 8, an error rate tree is generated for the vehicles of a particular model year (see e.g., 30 in FIG. 4). As shown in block 70, the number of vehicles N is 6,628,595 and the error rate is 0.93 for these vehicles. Block 72 illustrates that the next step in the tree separates the error rates according to engine type (see e.g., 50 in FIG. 4). Thus, engines of block 74 and engines of block 76 may be divided on two branches of the tree. As shown, engines of block 74 number 5,640,913 with an error rate of 0.96 while engines of block 76 number 987,682 with a survival rate of 0.74 . If desired, the tree may be further separated in branches based on model year in block 78, transmission type in block 80, transmission type in block 82, engine type in block 84, model year in block 86 and model year in block 88. Through each block, the number of vehicles in the subset is divided by the number of vehicles not having a particular defect. As such, as can be seen in the example, the vehicles in block 90, representing those vehicles that have the particular attributes as the lowest error rate. Specifically, the error rate is 0.30, indicating that 70% of the vehicles with those attributes have experienced an expiration of their useful life.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A method for determining a useful life of a vehicle, comprising:
estimating a size of at least one group of vehicles, wherein each vehicle in the group is bounded by a specified age range;
determining a size of a subgroup of vehicles within the at least one group of vehicles, wherein each vehicle in the subgroup of vehicles shares a common defect; and
calculating a useful life based on the size of the subgroup and the size of the group.

2. The method according to claim 1, wherein the determining step determines the size of the subgroup based on repair information of each vehicle in the at least one group.

3. The method according to claim 1 wherein the common defect is a defect of a specified component that is found in each vehicle within the subgroup.

4. The method according to claim 1, wherein the specified age range is defined by a specified mileage range.

5. The method according to claim 12, further comprising:
calculating a subset useful life for at least one subset of the vehicles in the at least one group of vehicles;
wherein the subset contains vehicles in the subgroup of vehicles that share a common attribute.

6. The method according to claim 5, wherein the subset useful life is a number of vehicles in the subgroup that are also members of the subset divided by a number of vehicles of the subgroup.

7. The method according to claim 5, wherein the subset useful life has a decision tree process for determining the subset useful life.

8. The method according to claim 5, wherein:
the subset useful life calculating step calculates a second subset useful life for at least a second subset of the vehicles;
wherein the second subset contains vehicles of the group that have a second common attribute.

9. The method according to claim 8, further comprising:
deciding on a lowest useful life between the first useful life and the second useful life;
whereby the deciding step at least in part explains the variance of the useful life of the common defect.

10. The method according to claim 5, wherein the common attribute is a vehicle type, transmission type, component type, manufacturing location or a vehicle driver type.

11. The method according to claim 1, wherein the estimating step uses a Kaplan-Meier survival estimate to estimate the size of the group.
